(19) United States
(12) Patent Application Publication
(10) Pub. No.: US 2025/0274024 A1
(43) Pub. Date: Aug. 28, 2025

(54) RESILIENT SHEET STRUCTURE AND VOICE COIL MOTOR

(71) Applicant: Luxshare Intelligent Manufacture Technology (Changshu) Co., Ltd, Changshu City (CN)

(72) Inventors: Po-Ying Tseng, Changshu City (CN); Kai-Jing FU, Changshu City (CN); Chen-Yu CHAO, Changshu City (CN)

(73) Assignee: Luxshare Intelligent Manufacture Technology (Changshu) Co., Ltd, Changshu City (CN)

(21) Appl. No.: 18/913,122

(22) Filed: Oct. 11, 2024

(30) Foreign Application Priority Data
Feb. 26, 2024 (CN) 202410207833.9

(51) Int. Cl. H02K 33/02

(52) U.S. Cl. CPC H02K 33/02; H02K 2203/09

(57) ABSTRACT

Provided are a resilient sheet structure and a voice coil motor. The resilient sheet structure includes a connection piece and a resilient sheet. The resilient sheet includes a fixed portion, a beam, and a fitting portion. The fixed portion is electrically connected to the connection piece and is configured to be connected to the base assembly of a voice coil motor. One end of the beam is connected to the fixed portion, and the other end of the beam can rotate around one end of the beam to enable the beam to be at an included angle with a preset plane. The fitting portion is connected to the other end of the beam, and the fitting portion can rotate around the beam to enable the fitting portion to be parallel to the preset plane.

### CROSS-REFERENCE TO RELATED APPLICATION(S)

This application claims priority to Chinese Patent Application No. 202410207833.9 filed Feb. 26, 2024, the disclosure of which is incorporated herein by reference in its entirety.

### TECHNICAL FIELD

The present invention relates to the field of voice coil motor technology and, in particular, to a resilient sheet structure and a voice coil motor.

### BACKGROUND

A voice coil motor is an apparatus for converting electrical energy into mechanical energy and may implement a straight-line motion and a motion with a limited swing angle. The voice coil motor uses the interaction between the magnetic poles in the magnetic field from a permanent magnet and the magnetic field generated by an energized coil conductor to produce a regular motion.

The structure of the existing voice coil motor generally includes a carrier, and a channel is disposed in the carrier and configured to assemble the lens of a camera. A coil is disposed around the periphery of the carrier, and the corresponding coil is provided with a magnet. Thus, when the coil is energized, the carrier generates displacement in the same direction as electromagnetic induction force due to electromagnetic induction, thereby implementing zooming and focusing of the camera. At least one of the upper end surface and the lower end surface of the carrier is also fixedly connected to a resilient sheet. The resilient sheet is elastic and may deform under the action of the electromagnetic induction force. When the coil is not energized, the carrier can be restored to the initial state under the elastic force of the resilient sheet.

In the related art, as shown in FIG. 15, the resilient sheet 100 generally includes a resilient sheet corner 1001 and a connection portion. The resilient sheet corner 1001 is connected to the resilient sheet connection region of a base 400. The connection portion is connected to the lens located inside the voice coil motor to enable the resilient sheet to stabilize a moving lens through the connection portion. The resilient sheet 100 is usually fixed on the resilient sheet connection region by fusion and riveting. More specifically, the resilient sheet 100 is connected to a terminal 200 protruding from the resilient sheet connection region by fusion and is fixed on the resilient sheet connection region through a riveting member 300. To improve the connection effect between the resilient sheet 100 and the terminal 200, the riveting member 300 needs to be arranged on two sides of the connection part between the resilient sheet 100 and the terminal 200, reducing the degree of freedom of design. The riveting position on the resilient sheet connection region is fixed, so that the riveting position cannot be adjusted according to the height of the terminal 200. When the height of the terminal 200 is relatively high, a problem that the riveting position of the resilient sheet 100 cannot correspond to the riveting position on the resilient sheet connection region may occur, which may affect the fixed effect of the resilient sheet 100 and easily cause instability. As a result, the stable electrical connection between the resilient sheet 100 and the terminal 200 is affected, and the normal use of the voice coil motor is affected.

### SUMMARY

The object of the present invention is to provide a resilient sheet structure and a voice coil motor. The resilient sheet structure can be suitable for flush-fitting with terminals of different heights, which has high connection stability and reliability.

As conceived previously, the following describes the solution of the present invention.

The resilient sheet structure includes a connection piece and a resilient sheet.

The resilient sheet includes a fixed portion, a beam, and a fitting portion. The fixed portion is electrically connected to the connection piece and is configured to be connected to the base assembly of the voice coil motor. One end of the beam is connected to the fixed portion, and the other end of the beam can rotate around one end of the beam, so that the beam is at an included angle with a preset plane. The fitting portion is connected to the other end of the beam, and the fitting portion can rotate around the beam, so that the fitting portion is parallel to the preset plane, and the fitting portion can be in flat contact with and be electrically connected to the top surface of the terminal on the base assembly.

The voice coil motor includes the resilient sheet structure as described above, the base assembly, and a coil assembly.

The base assembly includes a base, a connector, and a terminal. The base has a resilient sheet connection region. The connector is configured to fix the fixed portion of the resilient sheet structure to the resilient sheet connection region. The terminal is disposed on the base, and an end of the terminal extends to the resilient sheet connection region. The fitting portion of the resilient sheet structure is electrically connected to the terminal.

The coil assembly is disposed on the base assembly. The coil assembly includes a magnetic member disposed on the base assembly, a wire post electrically connected to the connection piece, a frame disposed on the base and formed with an annular groove, and a coil disposed on the annular groove and electrically connected to the wire post.

### BRIEF DESCRIPTION OF DRAWINGS

FIG. 1 is view one illustrating the structure of a voice coil motor according to an embodiment of the present invention.

FIG. 2 is exploded view one of a voice coil motor according to an embodiment of the present invention.

FIG. 3 is exploded view two of a voice coil motor according to an embodiment of the present invention.

FIG. 4 is a view of a base and a resilient sheet structure according to an embodiment of the present invention.

FIG. 5 is a view of a resilient sheet structure according to an embodiment of the present invention.

FIG. 6 is an assembly view of a resilient sheet structure and a terminal according to an embodiment of the present invention.

FIG. 7 is a view illustrating the structure of a resilient sheet according to an embodiment of the present invention.

FIG. 8 is a top view of a resilient sheet structure according to an embodiment of the present invention.

FIG. 9 is a top view of a resilient sheet structure according to another embodiment of the present invention.

FIG. 10 is a top view of a resilient sheet structure according to yet another embodiment of the present invention.

FIG. 11 is a top view of a resilient sheet structure according to still yet another embodiment of the present invention.

FIG. 12 is a top view of a resilient sheet structure according to even still yet another embodiment of the present invention.

FIG. 13 is a size mark view of a resilient sheet according to an embodiment of the present invention.

FIG. 14 is a diagram showing the variation of the angle at which the other end of a beam rotates around one end of the beam with the distance between a fitting portion and the top surface of a terminal according to an embodiment of the present invention.

FIG. 15 is a view illustrating the structure of part of a voice coil motor in the related art according to an embodiment of the present invention.

### REFERENCE LIST

10 resilient sheet structure
1 connection piece
2 resilient sheet
21 fixed portion
211 riveting hole
22 beam
23 fitting portion
231 welding hole
24 torsion bar portion
3 connection section
20 base assembly
201 base
2011 resilient sheet connection region
202 connector
203 terminal
2031 connection surface
2032 welding object
30 coil assembly
40 outer housing
X first direction
Y second direction
Z third direction
100 resilient sheet
1001 resilient sheet corner
200 terminal
300 riveting member
400 base

### DETAILED DESCRIPTION

It is to be noted that similar reference numerals and letters represent similar items in the drawings. Therefore, once an item is defined in one drawing, the item no longer needs to be defined and interpreted in the subsequent drawings.

In the description of the present invention, unless otherwise expressly specified and limited, the term “connected to each other”, “connected” or “secured” is to be construed in a broad sense, for example, as securely connected, detachably connected or integrated; mechanically connected or electrically connected; directly connected to each other or indirectly connected to each other via an intermediary; or internal connection between two components or interaction relations between two components. For those of ordinary skill in the art, specific meanings of the preceding terms in the present invention may be construed based on specific situations.

In the present invention, unless otherwise expressly specified and limited, when a first feature is described as “above” or “below” a second feature, the first feature and the second feature may be in direct contact or be in contact via another feature between the two features. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below” or “underneath” the second feature, the first feature is right under, below or underneath the second feature, the first feature is obliquely under, below or underneath the second feature, or the first feature is simply at a lower level than the second feature. In the description of the embodiments, unless otherwise specified, “multiple” specifically refers to two or more.

In the description of the embodiments, the orientation or position relationships indicated by terms “above”, “below”, “right” and the like are based on the orientation or position relationships shown in the drawings. These orientations or position relationships are merely for ease of description and simplifying an operation and do not indicate or imply that the referred device or element has a specific orientation and is constructed and operated in a specific orientation. Thus, these orientations or position relationships are not to be construed as limiting the present invention. In addition, the terms “first” and “second” are used only for distinguishing between descriptions and have no special meaning.

An embodiment provides a voice coil motor having high connection stability and reliability.

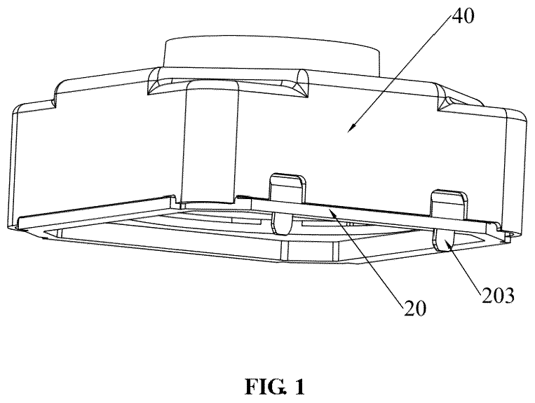

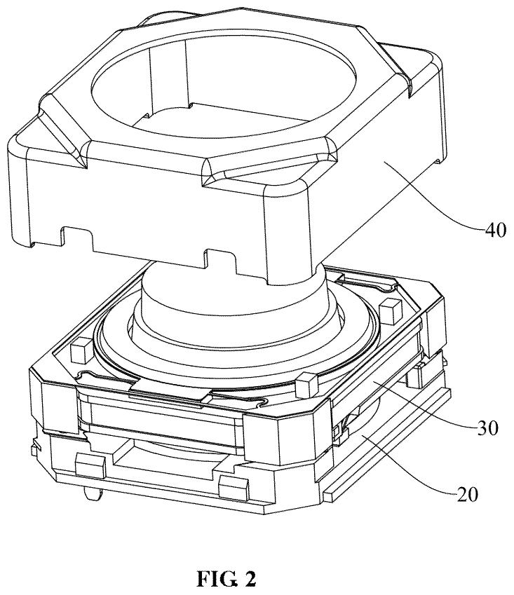

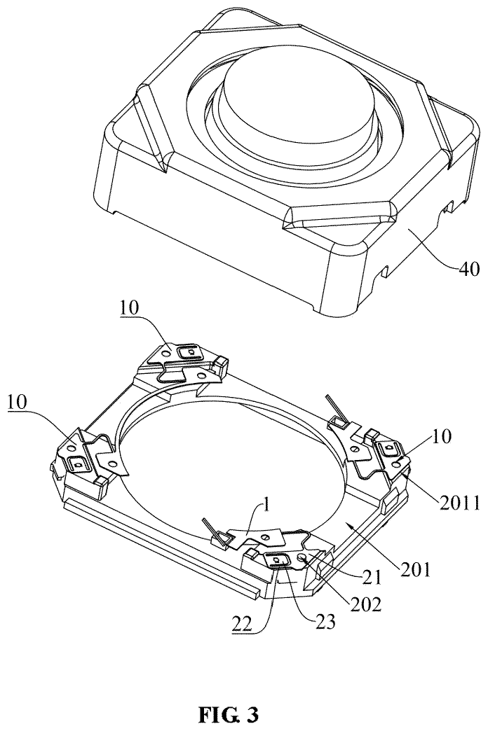

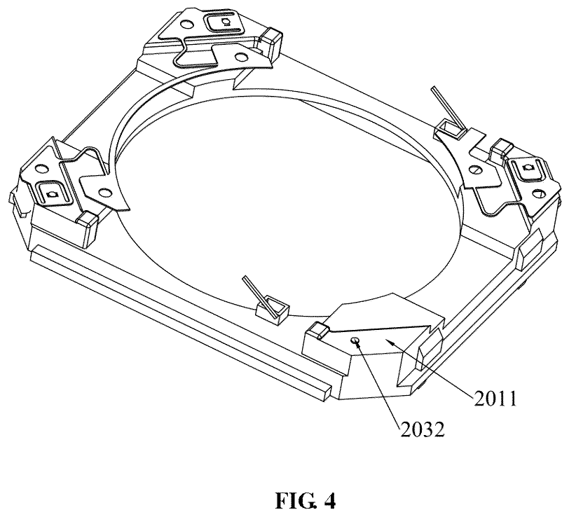

As shown in FIGS. 1 to 4, the voice coil motor includes a base assembly 20, a coil assembly 30, and a resilient sheet structure 10. The base assembly 20 includes a base 201, a connector 202, and a terminal 203. The base 201 has a resilient sheet connection region 2011. The resilient sheet connection region 2011 may be disposed on the top of the base 201. The connector 202 is configured to fix the resilient sheet structure 10 on the resilient sheet connection region 2011, so that the resilient sheet structure 10 is connected to the base assembly 20. The terminal 203 is disposed on the base 201. Specifically, one end of the terminal 203 extends to the resilient sheet connection region 2011, and the other end of the terminal 203 protrudes from the bottom of the base 201 to be electrically connected to other electronic devices.

The resilient sheet structure 10 is electrically connected to the part of the terminal 203 located in the resilient sheet connection region 2011. In some optional embodiments, the terminal 203 has a connection surface 2031 exposed from the resilient sheet connection region 2011. The resilient sheet structure 10 is electrically connected to the connection surface 2031. For example, the connection method between the resilient sheet structure 10 and the terminal 203 may be laser welding, so that the connection effect is better. When the resilient sheet structure 10 is connected to the terminal 203, as shown in FIG. 6, a welding object 2032 may be disposed between the resilient sheet structure 10 and the terminal 203, and the welding object 2032 may be fused so that the resilient sheet structure 10 is connected to the terminal 203.

The coil assembly 30 is disposed on the base assembly 20. The coil assembly 30 includes a magnetic member disposed on the base assembly 20, a wire post electrically connected to the resilient sheet structure 10, a frame disposed on the base 201 and formed with an annular groove, and a coil disposed on the annular groove and electrically connected to the wire post. In some optional embodiments, the voice coil motor also includes an upper resilient sheet. The upper resilient sheet is disposed on the frame.

In some embodiments, the voice coil motor also includes an outer housing 40. The outer housing 40 covers at least part of the base assembly 20 and the coil assembly 30. The outer housing 40 is configured to protect the base assembly 20 and the coil assembly 30 to prevent moisture or dust from entering each component and causing a decrease in the service life of an element.

In some embodiments, the terminal 203 may also have an input/output end. The coil, the wire post, the resilient sheet structure 10, and the terminal 203 form a circuit with a power supply through the input/output end to match the magnetic member to move the lens (not shown) located at the center of the voice coil motor. In other words, a current enters the coil from the input/output end of the terminal 203 along the resilient sheet structure 10 and the wire post to form an electric field. The magnetic field generated by the preceding electric field may interact with the magnetic member and move the lens located at the center of the voice coil motor.

This embodiment may describe the resilient sheet structure 10 in detail below.

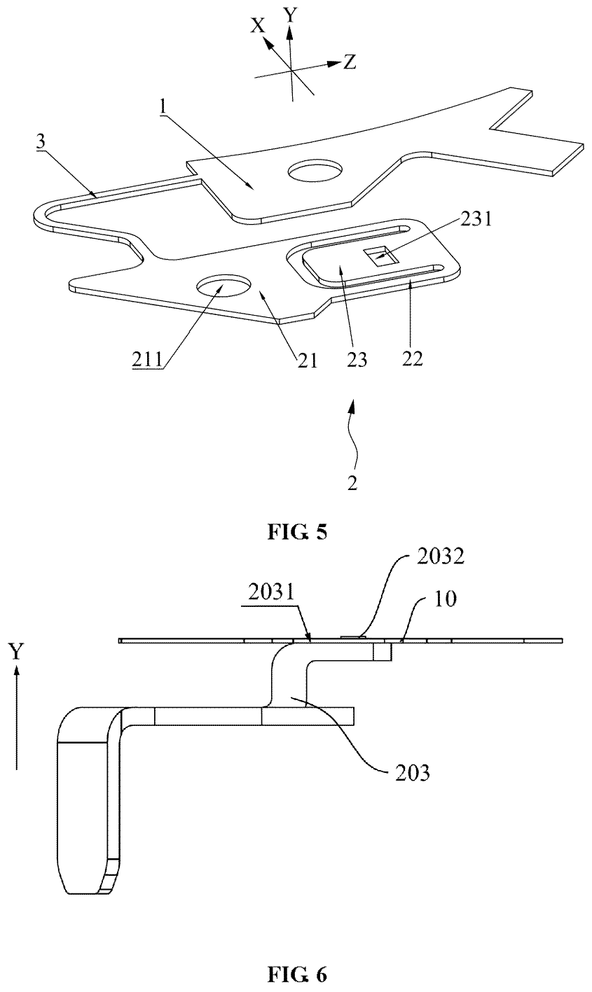

As shown in FIGS. 5 to 13, the resilient sheet structure 10 includes a connection piece 1 and a resilient sheet 2. The connection piece 1 is configured to be electrically connected to the coil. In some optional embodiments, as shown in FIG. 5, the connection piece 1 may be fixedly and electrically connected to the resilient sheet 2 through a connection section 3. In this embodiment, the resilient sheet 2 and the connection piece 1 are sheet-shaped.

Referring to FIG. 5, the resilient sheet 2 includes a fixed portion 21, a beam 22, and a fitting portion 23. The fixed portion 21 is fixed and electrically connected to the connection piece 1, and the fixed portion 21 is configured to be connected to the resilient sheet connection region 2011 of the base 201, that is, the fixed portion 21 is fixed on the resilient sheet connection region 2011 through the connector 202. In some optional embodiments, the fixed portion 21 is formed with a riveting hole 211. The fixed portion 21 may be fixed on the resilient sheet connection region 2011 by a riveting and pressing process.

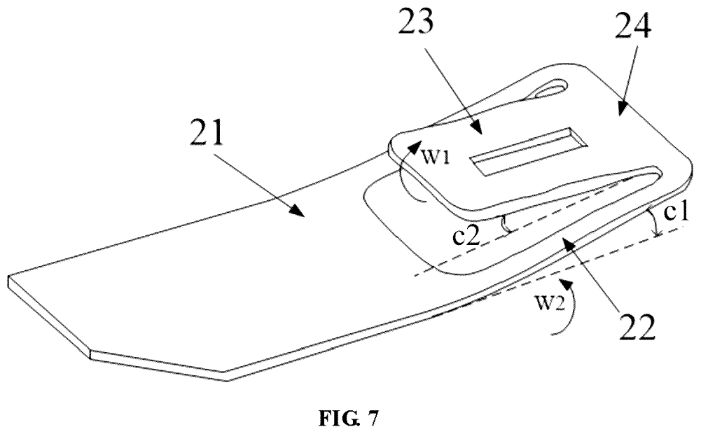

One end of the beam 22 is connected to the fixed portion 21, and the fitting portion 23 is connected to the other end of the beam 22. The other end of the beam 22 can rotate around one end of the beam 22, that is, the other end of the beam 22 can rotate with one end of the beam 22 as a fulcrum, so that the beam 22 is at an included angle with a preset plane. The preset plane may overlap or be parallel to the connection surface 2031. For example, as shown in FIG. 7, when the beam 22 rotates to an inclined state, the included angle between the beam 22 and the preset plane is c1. It is to be noted that when the other end of the beam 22 rotates around one end of the beam 22, the fitting portion 23 can be driven to rotate together, that is, the fitting portion 23 can rotate relative to one end of the beam 22.

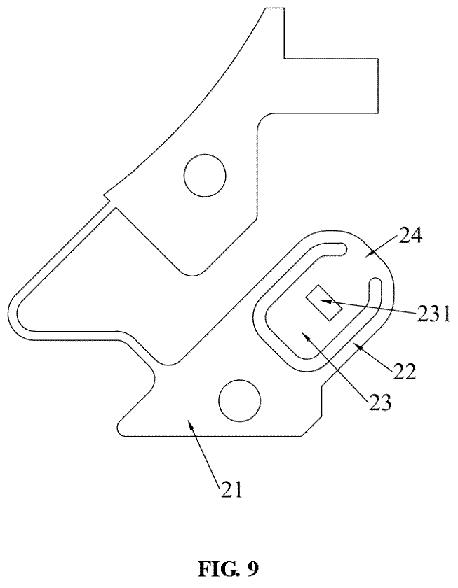

In this embodiment, the fitting portion 23 can rotate around the beam 22, that is, the fitting portion 23 can rotate with the beam 22 as a fulcrum or a rotation shaft. The rotation direction of the other end of the beam 22 relative to one end of the beam 22 is opposite to the rotation direction of the fitting portion 23 relative to the beam 22, so that the fitting portion 23 is parallel to the preset plane. Thus, the fitting portion 23 can be in flat contact with and electrically connected to the connection surface 2031 of the terminal 203 on the base assembly 20. For example, after the fitting portion 23 rotates around the beam 22, the included angle between the fitting portion 23 and the beam 22 is c2. When c1=c2, that is, when the angle at which the other end of the beam 22 rotates around one end of the beam 22 is equal to the angle at which the fitting portion 23 rotates around the beam 22, the fitting portion 23 is parallel to the preset plane, and the preset plane is parallel to or overlaps the connection surface 2031, so that the fitting portion 23 can be in flat contact with the connection surface 2031. The fitting portion 23 is plate-like to better contact with the terminal 203. The fitting portion 23 is connected to the terminal 203 in a laser fusion manner, so that the connection reliability is relatively high. For example, as shown in FIG. 9, the fitting portion 23 is planar-ring shaped and is formed with a welding hole 231. The welding hole 231 is configured to place a welding object 2032 between the fitting portion 23 and the terminal 203.

When the resilient sheet structure 10 provided in this embodiment is used, the connection piece 1 may be electrically connected to the coil. Then, the fixed portion 21 is connected to the resilient sheet connection region 2011 of the base 201. Alternatively, the fixed portion 21 may also be connected to the resilient sheet connection region 2011 of the base 201. Then, the connection piece 1 may be electrically connected to the coil. This is not limited in this embodiment. At this time, the fixed portion 21, the beam 22, and the fitting portion 23 are coplanar and in a horizontal state. For example, the fixed portion 21, the beam 22, and the fitting portion 23 are in contact with the resilient sheet connection region 2011 of the base 201. Alternatively, when the terminal 203 protrudes from the resilient sheet connection region 2011, that is, when the height of the terminal 203 is relatively high, the fitting portion 23 may be in a tilted state. Specifically, the fitting portion 23 tilts up in a second direction Y shown in FIG. 5. Next, the other end of the beam 22 is controlled to rotate around one end of the beam 22. At this time, the other end of the beam 22 drives the fitting portion 23 to move in a direction away from the base 201 until there is an included angle between the beam 22 and the top surface of the base 201. Then, the fitting portion 23 is controlled to rotate around the other end of the beam 22, so that there is an included angle between the fitting portion 23 and the beam 22 until the fitting portion 23 can fully contact with the connection surface 2031 of the terminal 203, that is, the fitting portion 23 is parallel to the preset plane. Then, laser welding is performed between the fitting portion 23 and the terminal 203.

The resilient sheet structure 10 is provided in this embodiment, the resilient sheet 2 includes a fixed portion 21, a beam 22, and a fitting portion 23. The fixed portion 21 is connected to the resilient sheet connection region 2011 of the base 201. One end of the beam 22 is connected to the fixed portion 21, and the other end of the beam 22 is connected to the fitting portion 23. The other end of the beam 22 can rotate around one end of the beam 22, that is, the beam 22 rotates from a state in which the beam 22 is parallel to the preset plane to an inclined state that the beam 22 is at an included angle with the preset plane. That is, the other end of the beam 22 can be tilted relative to the fixed portion 21. Specifically, the beam 22 is tilted relative to the fixed portion 21 in the second Y direction shown in FIG. 5. The fitting portion 23 is disposed at the other end of the beam 22. When the other end of the beam 22 rotates around the one end of the beam 22, the fitting portion 23 may also move along with the other end of the beam 22, and the fitting portion 23 can rotate independently around the other end of the beam 22. Since the tilted height of the beam 22 relative to the base 201 and the angle of the fitting portion 23 around the other end of the beam 22 are adjustable, the distance between the fitting portion 23 and the base 201 is adjusted, which is applicable to terminals 203 of different heights. Thus, the flexibility of the fitting portion 23 is improved, and it is convenient for the fitting portion 23 to be parallel to the connection surface 2031, so that the fitting portion 23 can be flush-fitting with the connection surface 2031, and the fitting portion 23 and the connection surface 2031 have a relatively large contact area. Moreover, the connection stability and reliability between the fitting portion 23 and the terminal 203 are improved, and the normal use of the voice coil motor that applies the resilient sheet structure 10 is ensured.

Moreover, since the fitting portion 23 has a degree of freedom, the number and the position of the riveting and pressing on the fixed portion 21 are not limited.

It is to be noted that to improve the integrity of the resilient sheet 2, the resilient sheet 2 is a one-piece construction. Furthermore, the resilient sheet structure 10 is a one-piece construction, that is, the resilient sheet structure 10 can be formed by stamping and cutting a plate.

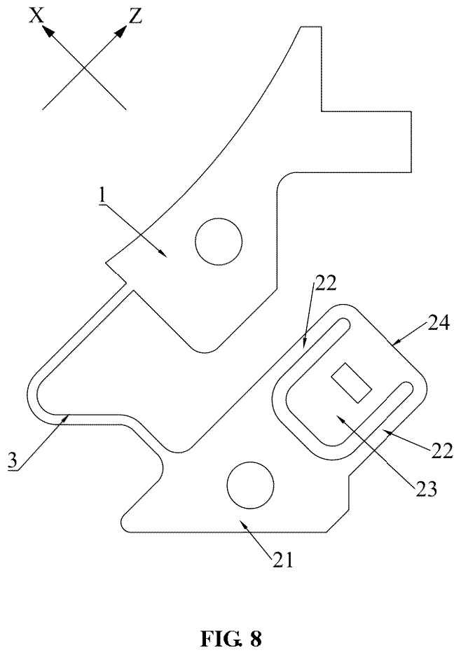

As shown in FIGS. 7 and 8, the resilient sheet 2 also includes a torsion bar portion 24. The other end of the beam 22 is connected to the torsion bar portion 24. The fitting portion 23 is connected to the torsion bar portion 24, that is, the other end of the beam 22 is connected to the fitting portion 23 through the torsion bar portion 24. The fitting portion 23 can rotate around the torsion bar portion 24. With the arrangement of the bar portion 24, the flexibility of the resilient sheet structure 10 can be further improved and the torsional stress between the fitting portion 23 and the beam 22 can also be adjusted.

In some optional embodiments, the torsion bar portion 24 can rotate around the beam 22. The rotation axis of the torsion bar portion 24 is parallel to the rotation axis of the beam 22. The torsion bar 24 can rotate around the beam 22 to further adjust the distance between the fitting portion 23 and the top surface of the base 201, so that the resilient sheet structure 10 is more flexible. In some optional embodiments, the extension direction of the torsion bar portion 24 is perpendicular to the extension direction of the beam 22. In other optional embodiments, the extension direction of the torsion bar portion 24 may be at an included angle with the extension direction of the beam 22. In this embodiment, the torsion bar portion 24 extends in a first direction X.

For example, the beam 22, the torsion bar portion 24, and the fitting portion 23 are all located on the same side of the fixed portion 21. More specifically, the beam 22, the torsion bar portion 24, and the fitting portion 23 are all located on a side of the fixed portion 21 in a third direction Z, it is convenient that the beam 22, the torsion bar portion 24, and the fitting portion 23 are tilted relative to the fixed portion 21, and the fitting portion 23 is connected to the terminal 203.

There may be one or more beams 22. This is not limited in this embodiment.

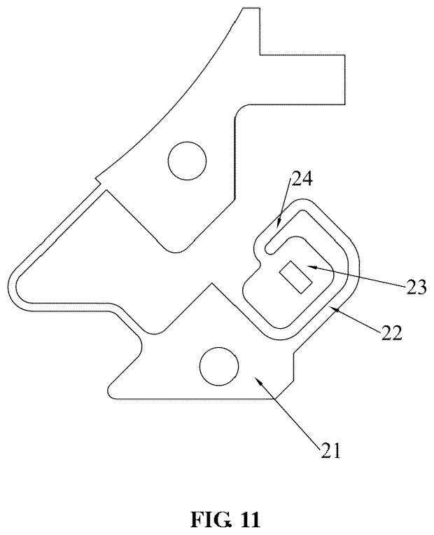

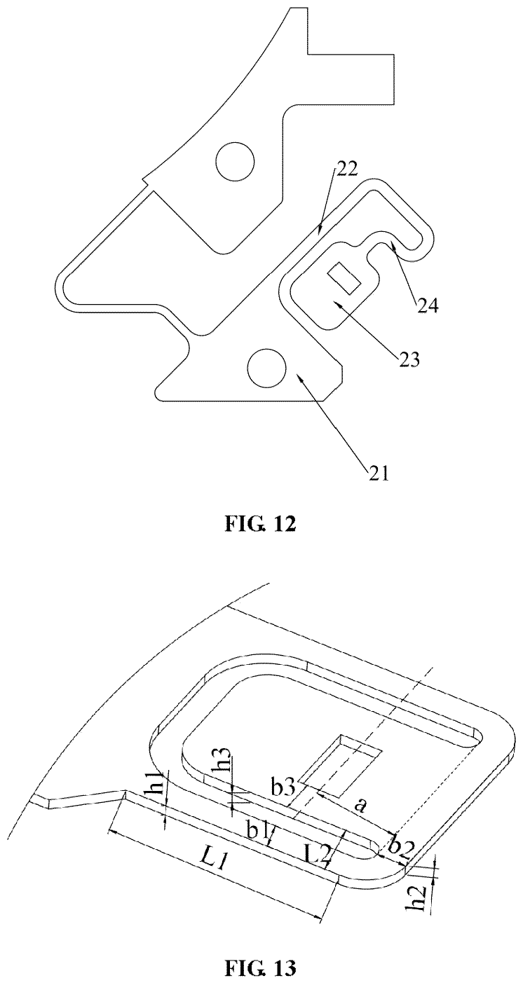

In some optional embodiments, as shown in FIGS. 11 and 12, one beam 22 is provided. The fitting portion 23 is located on a side of the beam 22 and is spaced apart from the middle portion of the beam 22.

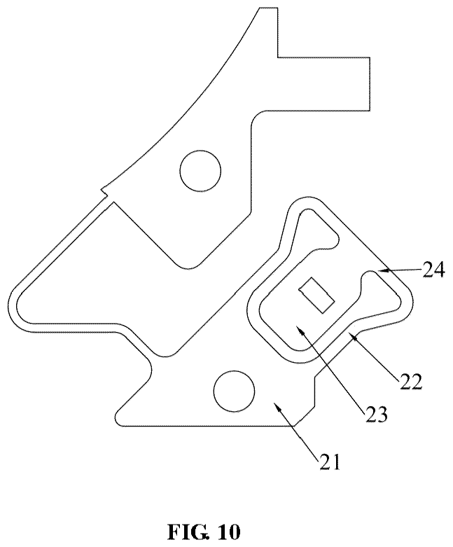

In other optional embodiments, as shown in FIGS. 9 and 10, two beams 22 are provided. The two beams 22 are disposed at intervals in the first direction X. The end of each of two beams 22 is connected to the fixed portion 21, and the other ends of the two beams 22 are connected to the fitting portion 23. With the arrangement of the two beams 22, the reliability for connecting the fitting portion 23 is improved.

Continuously referring to FIGS. 9 and 10, when two beams 22 are provided, the fitting portion 23 is located between the two beams 22 in the first direction X. In other embodiments, the fitting portion 23 may also be located outside the two beams 22 instead of between the two beams 22. This is not limited in this embodiment.

The beam 22 having the preceding two structures can be tilted relative to the fixed portion 21, so that there is a certain distance between the fitting portion 23 and the base 201.

In this embodiment, the beam 22 is any one or a combination of a straight-line structure, a curved structure, or a bent-line structure, which may be specifically selected or designed according to an application position or other scenarios. This is not limited in this embodiment. The beam 22 in FIG. 8 is a straight-line structure. The beams 22 in FIG. 9 and FIG. 10 are bent-line structures and specifically include two line segments. The difference is that the bending directions of the two line segments are different. The beams 22 in FIG. 11 and FIG. 12 are combinations of a bent-line structure and a curved structure.

FIG. 13 is a view of part of the resilient sheet structure 10 according to this embodiment, and in FIG. 13, the beam 22, the fitting portion 23, and the torsion bar portion 24 are marked with sizes.

A calculation is performed according to the material mechanics. The rotation angle formulas of the beam 22, the torsion bar portion 24, and the fitting portion 23 are listed, so that the position where the rotation angle is zero (that is, the fitting portion 23 has no inclination) may be obtained. This position may also be obtained by analog simulation.

The rotation angle formula of the beam 22 includes two parts, one part is

$${θ}_{max} = \frac{{FL}^{2}}{2 EI}$$

and the other part is

$${θ}_{max} = \frac{{M}_{0} L}{EI} .$$

The rotation angle formula of the torsion bar portion 24 is:

$$Δϕ = \frac{{M}_{0} L}{GJ} .$$

The rotation angle formula of the fitting portion 23 is:

$$θ = - \frac{{Fa}^{2}}{2 EI} .$$

According to the material mechanics theory, the derivation is available below.

$$\frac{{FL}^{2}}{2 {EI}_{1}} - \frac{{M}_{0} {L}_{1}}{{EI}_{1}} - \frac{{M}_{0} {L}_{2}}{{GJ}_{2}} - \frac{{Fa}^{2}}{2 {EI}_{3}} = 0 \{ \begin{matrix}{M}_{0} = F \cdot a \\ G = \frac{E}{2 ( 1 + v )}\end{matrix}$$

$$\frac{1}{{I}_{3}} {a}^{2} + ( \frac{2 {L}_{1}}{{I}_{1}} - \frac{4 ( 1 + v ) {L}_{2}}{{J}_{2}} ) a - \frac{{L}^{2}}{{I}_{1}} = 0$$

$$a = \frac{- ( \frac{2 {L}_{1}}{{I}_{1}} - \frac{4 ( 1 + v ) {L}_{2}}{{J}_{2}} ) \pm \sqrt{{( \frac{2 {L}_{1}}{{I}_{1}} - \frac{4 ( 1 + v ) {L}_{2}}{{J}_{2}} )}^{2} - 4 \frac{1}{{I}_{3}} ( - \frac{{L}^{2}}{{I}_{1}} )}}{2 \frac{1}{{I}_{3}}}$$

In the preceding derivation process, F denotes the force on a component. M₀ denotes torque. E, I, v, and J are constants in the material mechanics. E denotes a tensile modulus of elasticity. I denotes a moment of inertia. G denotes a shear modulus of elasticity. J denotes compliance. v denotes a Poisson's ratio. In subscripts, 1 denotes the parameter corresponding to the beam 22, 2 denotes the parameter corresponding to the torsion bar portion 24, and 3 denotes the parameter corresponding to the fitting portion 23. As shown in FIG. 13, the obtained position where a rotation angle is 0 is represented by a dashed line passing through the welding hole.

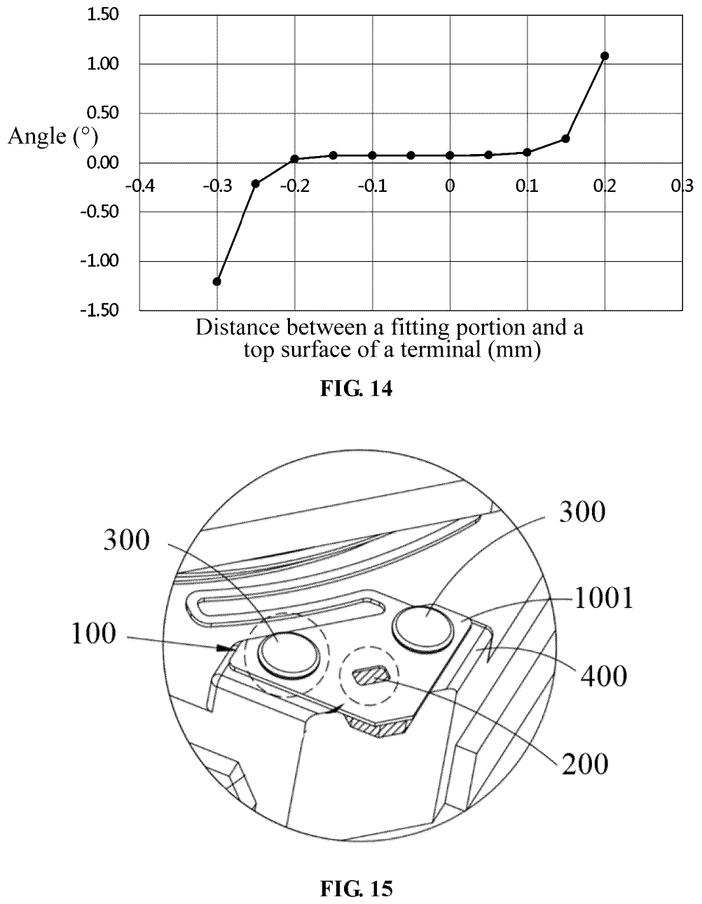

FIG. 14 is a line chart where the distance between the fitting portion 23 and the top surface (that is, the connection surface 2031) of the terminal 203 corresponds to the angle at which the other end of the beam 22 rotates around one end of the beam 22 according to this embodiment. It can be seen that as long as the terminal 203 covers a non-inclined position, the fitting portion 23 of the resilient sheet structure 10 may always remain in flat contact with the connection surface 2031 of the terminal 203.

The resilient sheet structure 10 provided in this embodiment uses geometric design to implement an adaptive structure. There is no limit to the rigidity of the resilient sheet structure 10. Regardless of whether the rigidity is large or small, the fitting portion 23 of the resilient sheet structure 10 may be in flat contact with the connection surface 2031 of the terminal 203. The protrusion height of the terminal 203 does not affect the gap between the fitting portion 23 of the resilient sheet structure 10 and the connection surface 2031, so that the fitting portion 23 is completely in flat contact with the surface of the terminal 203 without any gap, thereby increasing the robustness of the manufacturing process of the product.

What is claimed is:

1. A resilient sheet structure, comprising:
a connection piece; and
a resilient sheet comprising a fixed portion, a beam, and a fitting portion, wherein the fixed portion is electrically connected to the connection piece and is configured to be connected to a base assembly of a voice coil motor; one end of the beam is connected to the fixed portion, and another end of the beam is capable of rotating around the one end of the beam to enable the beam to be at an included angle with a preset plane; and the fitting portion is connected to the another end of the beam, and the fitting portion is capable of rotating around the beam to enable the fitting portion to be parallel to the preset plane and to enable the fitting portion to be in contact with and to be electrically connected to a top surface of a terminal on the base assembly.

2. The resilient sheet structure according to claim 1, wherein the resilient sheet further comprises a torsion bar portion, the another end of the beam is connected to the torsion bar portion, the fitting portion is connected to the torsion bar portion, the torsion bar portion is capable of rotating around the beam, and the fitting portion is capable of rotating around the torsion bar portion.

3. The resilient sheet structure according to claim 1, wherein one beam is provided, and the fitting portion is located on a side of the beam.

4. The resilient sheet structure according to claim 1, wherein two beams are provided, the two beams are disposed at intervals in a first direction, one end of each of the two beams is connected to the fixed portion, and another end of each of the two beams is connected to the fitting portion.

5. The resilient sheet structure according to claim 4, wherein the fitting portion is located between the two beams in the first direction.

6. The resilient sheet structure according to claim 1, wherein the beam is any one or a combination of a straight-line structure, a curved structure, or a bent-line structure.

7. The resilient sheet structure according to claim 2, wherein the beam is any one or a combination of a straight-line structure, a curved structure, or a bent-line structure.

8. The resilient sheet structure according to claim 3, wherein the beam is any one or a combination of a straight-line structure, a curved structure, or a bent-line structure.

9. The resilient sheet structure according to claim 1, wherein the resilient sheet is a one-piece construction.

10. The resilient sheet structure according to claim 1, wherein the beam and the fitting portion are located on a same side of the fixed portion.

11. The resilient sheet structure according to claim 1, wherein the fitting portion is planar-ring shaped and the fitting portion is formed with a welding hole.

12. A voice coil motor, comprising:
the resilient sheet structure;
the base assembly comprising a base, a connector, and the terminal, wherein the base has a resilient sheet connection region, the connector is configured to fix the fixed portion of the resilient sheet structure to the resilient sheet connection region, the terminal is disposed on the base, an end of the terminal extends to the resilient sheet connection region, and the fitting portion of the resilient sheet structure is electrically connected to the terminal; and
a coil assembly disposed on the base assembly, comprising a magnetic member disposed on the base assembly, a wire post electrically connected to the connection piece, a frame disposed on the base and formed with an annular groove, and a coil disposed in the annular groove and electrically connected to the wire post;
wherein the resilient sheet structure, comprising:
a connection piece; and
a resilient sheet comprising a fixed portion, a beam, and a fitting portion, wherein the fixed portion is electrically connected to the connection piece and is configured to be connected to a base assembly of a voice coil motor; one end of the beam is connected to the fixed portion, and another end of the beam is capable of rotating around the one end of the beam to enable the beam to be at an included angle with a preset plane; and the fitting portion is connected to the another end of the beam, and the fitting portion is capable of rotating around the beam to enable the fitting portion to be parallel to the preset plane, and to enable the fitting portion fit to and being electrically connected to a top surface of a terminal on the base assembly.

13. The voice coil motor according to claim 12, wherein the resilient sheet further comprises a torsion bar portion, the another end of the beam is connected to the torsion bar portion, the fitting portion is connected to the torsion bar portion, the torsion bar portion is capable of rotating around the beam, and the fitting portion is capable of rotating around the torsion bar portion.

14. The voice coil motor according to claim 12, wherein one beam is provided, and the fitting portion is located on a side of the beam.

15. The voice coil motor according to claim 12, wherein two beams are provided, the two beams are disposed at intervals in a first direction, one end of each of the two beams is connected to the fixed portion, and another end of each of the two beams is connected to the fitting portion.

16. The voice coil motor according to claim 15, wherein the fitting portion is located between the two beams in the first direction.

17. The voice coil motor according to claim 12, wherein the beam is any one or a combination of a straight-line structure, a curved structure, or a bent-line structure.

18. The voice coil motor according to claim 12, wherein the resilient sheet is a one-piece construction.

19. The voice coil motor according to claim 12, wherein the beam and the fitting portion are located on a same side of the fixed portion.

20. The voice coil motor according to claim 12, wherein the fitting portion is planar-ring shaped and the fitting portion is formed with a welding hole.
